(19) United States
(12) Patent Application Publication
(10) Pub. No.: US 2013/0112357 A1
(43) Pub. Date: May 9, 2013

(54) Overhead Roll-Up Door Having At Least Two Motors

(71) Applicants: Christopher Gontarski, Sugar Hill, GA (US); Brian Norbert Drifka, Richfield, WI (US)

(72) Inventors: Christopher Gontarski, Sugar Hill, GA (US); Brian Norbert Drifka, Richfield, WI (US)

(73) Assignee: Rytec Corporation, Jackson, WI (US)

(21) Appl. No.: 13/333,629

(22) Filed: Dec. 21, 2011

Related U.S. Application Data
(60) Provisional application No. 61/555,569, filed on Nov. 4, 2011.

(51) Int. Cl. E06B 9/68

(52) U.S. Cl. 160/291; 160/311

(57) ABSTRACT

An overhead roll-up door assembly for a vertically moving door to permit and prohibit access to an opening, the door assembly having a flexible door panel, a shaft capable of rotating to vertically move the flexible door panel, and at least two motors configured to rotate the shaft.

### RELATED APPLICATIONS

This application claims priority U.S. Provisional Application Ser. No. 61/555,569 entitled “Overhead Roll-Up Door Having Dual Motors” filed Nov. 4, 2011, the contents of which are fully incorporated herein by reference.

### FIELD OF THE INVENTION

The present invention is related to overhead roll-up doors, and more specifically to an overhead roll-up door assembly having two motors for vertically moving a roll-up door panel.

### BACKGROUND OF THE INVENTION

Overhead roll-up door assemblies known in the art typically include a flexible door panel that is moved vertically by winding the door panel on and off a shaft or drum which is controlled by a motor. The shaft or drum and any unwound portion of the door panel are usually housed in a header located proximate the top of an opening the door panel is configured to permit and prohibit access to. In order to guide the vertical movement of the flexible door panel, door assemblies typically include side columns and/or vertical guide rails located proximate the horizontal boundaries of the opening. As the door panel is raised or lowered, the side columns generally engage or otherwise capture a portion of the marginal and/or lateral edges of the door panel, vertically guiding the panel as the door is opened or closed.

Vertical movement of the door panel is generally achieved by the motor rotating the shaft or drum. The motor may be directly attached to the shaft or drum, or, in some assemblies, may be connected using a drive belt or chain or other device which attaches the shaft of the motor to the shaft or drum used for winding and unwinding the door panel.

In industrial applications, in order to provide a maximum opening size and/or in order to provide a door to permit and prohibit access to very large openings, overhead door assemblies may incorporate large door panels. These large door panels may have substantial width and/or height. These door panels may also be heavy, particular if they are made from heavy duty materials such as Styrene-Butadiene-Rubber (“SBR”) and ethylene propylene diene Monomer rubber (“EPDM”). As is known in the art, the large size and/or weights of these door panels may put unwanted stress on the motor controlling the vertical movement of the panel, potentially leading to the door malfunctioning or motor failure.

In order to combat the stress created by a large and/or heavy door on a motor opening and closing the same and more effectively and efficiently opening and closing such doors, it is known in the art to attach a counterweight or torsion spring to the shaft or drum to counteract the stress on the motor.

For example, in embodiments using a counterweight, the motor may be attached to one end of the shaft or drum which winds and unwinds the door panel, while the counterweight is attached to the other end. The counterweight may be attached to the shaft or drum using a rope, chain, or other flexible object wherein one end is connected to the shaft or drum while the other end supports the weight of the counterweight. The rope, chain, strap, or other flexible object used to carry the counterweight may be configured to wind on the end of the shaft or drum in a manner which is opposite of the door panel—as the door panel is lowered the counterweight is raised, as the door panel is raised, the counterweight is lowered. Utilizing a counterweight helps reduce stress on the motor inasmuch as the weight of the lowering counterweight helps raise the door panel. Of course, if the door panel and counterweight become stuck and suspended in an intermediate position, the force on the motor may increase to prevent the door or counterweight from crashing down. The use of a counterweight also necessarily increases the sized of the door assembly as a channel for the counterweight must be configured in the design. The rope, chain, strap or other flexible object used to raise and lower the counterweight may also wear out, leading to the counterweight disengaging at an inopportune time, leading to the counterweight crashing in the side column or channel, damaging the door assembly and surrounding structures or objects.

In embodiments where a torsion spring is used, at least one torsion spring may be attached to the shaft or drum such that a force may be applied to wind or torque the spring as the door panel is lowered, with the spring unwinding as the door panel is raised. In other embodiments, torsion springs may be arranged in a similar manner as a counterweight wherein one end of the torsion spring is anchored in the base of the side column or channel located proximate the side column, and the other end of the torsion spring is connected to the shaft via a strap or other connecting means. In such embodiments, as the door panel is closed, the strap acts to pull one end of the torsion spring upwards as the door closes so the force of the torsion spring recoiling helps open the door. In embodiments using a strap or other connection means, as with a counterweight, the strap or other connection means may break, leading to the torsion spring collapsing to the floor, potentially damaging the side column, channel, and any surrounding structures or objects.

Regardless of which torsion spring embodiment is used, torsion springs are typically very expensive to purchase and replace, and require high levels of maintenance to insure proper operation. Torsion springs typically show no signs of wear and may just break or malfunction without notice. When a torsion springs break, it frequently leads to expensive, time consuming repairs which may lead to a door being inoperable for an extended period of time.

Regardless of whether a counterweight, torsion spring, or nothing at all is used to balance the door panel, the primary method known in the art for driving the drum or shaft with the motor is by directly connecting the motor to the drum or shaft. The single motor then rotates the drum or shaft clockwise or counterclockwise to raise and lower the door panel. While connecting the motor and shaft in this manner is simple and has few moving parts which may break, when the door panel is suspended, stalled, or being raised, the full force of the weight of the door is imparted on the motor. This may lead to the motor failing or breaking as the door panel is suspended or raised, leading to the door panel collapsing on objects below.

As such, it would be advantageous to create a door assembly capable of raising, holding, and lowering large door panels without utilizing counterweights or torsion springs.

The present invention is directed to solving these and other problems.

### SUMMARY OF THE INVENTION

The present invention is directed to an overhead roll-up door assembly having a flexible roll-up door panel wound and unwound from a shaft or drum rotated by at least two motors.

According to one aspect of the invention, a door assembly having a flexible door panel, a shaft or drum for winding and unwinding the door panel, and at least two motors for rotating the shaft or drum is provided.

The shaft or drum may include at least two substantially common sized gears (shaft gears). Each motor includes at least substantially common sized gear (motor gears) coupled to a motor, wherein the motor gears have a diameter less than the substantially identical diameter of the shaft gears. A flexible drive member may then couple each motor gear to a corresponding shaft gear in a manner such that the larger shaft gear increases the reverse torque of the motors (the torque imparted on the motor(s) in the direction of unwinding the door-panel towards a closed orientation). Accordingly, such increased torque will prevent the door panel from closing/further unwinding if one or both of the motors falters when the panel is open or partially open—even though the torque rating associated with the actual motor gears may not be high enough to withhold the weight load otherwise imparted thereon by the weight of the door panel.

The at least two motors should be synchronized and calibrated so as to rotate the shaft or drum at substantially the same rate in order to insure the door panel opens and closes in a substantially even and uniform manner. Assuming similar motors and motor gears are used, in order to rotate the shaft or drum at substantially the same rate, it should be appreciated by those having ordinary skill in the art that the motors and motor shafts must be calibrated to rotate at substantially the same rate. Once installed the speed with which each motor rotates may be adjusted in order to adjust the open and close rates of the door panel, so long as the speed of each motor is substantially identical.

It should be appreciated by those having ordinary skill in the art that more than two motors may be utilized in the overhead door assembly. Each motor may include a commonly sized gear which is operably connected to a corresponding shaft gear by a flexible drive member to raise and lower the door panel. Each motor gear and shaft gear may be arranged so as to increase the reverse torque and prevent the door panel from unwinding when the door panel is suspended in a partially or substantially opened position.

According to another aspect of the invention, at least one shaft gear is located proximate each end of the drum or shaft. In order to more easily engage each shaft gear with a motor gear, it is contemplated by the invention that at least one motor may be located proximate each end of the shaft or drum as well.

In alternative embodiments, it is contemplated that each of the at least two shaft gears and each of the at least two motors may be located on one side of the shaft or drum. However, in such embodiments, each shaft gear is operably engaged with only one motor gear so that each shaft gear is driven by a single motor.

According to still another aspect of the invention, a sensor may be used to detect engagement of each shaft gear to its respective motor gear.

According to another aspect of the invention, a sensor may be used to detect the rate of rotation of at least one of each motor shaft, the motor gears or the shaft gears.

According to yet another aspect of the invention, a sensor may be used to measure the current drawn by each motor.

According to still another aspect of the invention, a sensor may be used to measure the torque required by each motor to vertically move the door panel.

According to another aspect of the invention, the door assembly may include a means for manually operating the motor and rotating the shaft to vertically move the door panel.

According to one aspect of the invention, each of the at least two motors may be directly attached to the drum or shaft in order to rotate the drum or shaft directly, without the use of any gears or drive members. Direct attachment may be done on either end of the shaft or drum, or alternatively on one end of the shaft or drum. In embodiments where more than two motors are used, the motors may be configured such that at least one motor is located on each side of the shaft or drum or every motor is located on a single side of the shaft or drum.

Other aspects and features of the invention will become apparent to those having ordinarily skill in the art upon review of the following Detailed Description, Claims, and associated Drawings.

### BRIEF DESCRIPTION OF THE DRAWINGS

FIG. 1 is a front view of an embodiment of a door assembly as contemplated by the present invention.

FIG. 2 is a side view of an embodiment of a door assembly as contemplated by the present invention.

FIG. 3 is a front view of an embodiment of a door assembly as contemplated by the present invention.

FIG. 4 is a side view of an embodiment of a door assembly as contemplated by the present invention.

FIG. 5 is a perspective view of an embodiment of a header, shaft, and motors of a door assembly as contemplated by the present invention.

### DETAILED DESCRIPTION OF THE PRESENT INVENTION

While the present invention is susceptible of embodiment in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

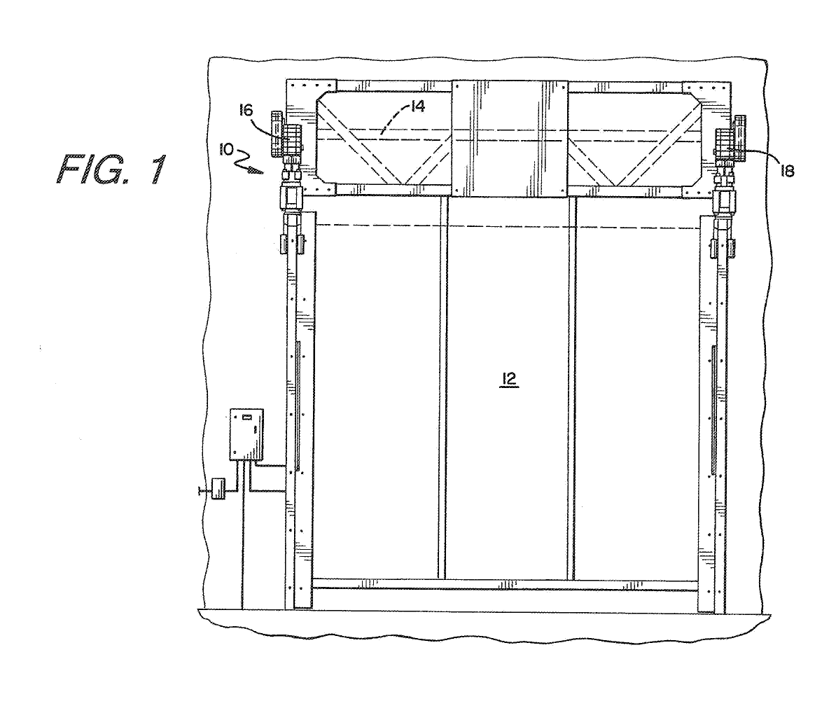

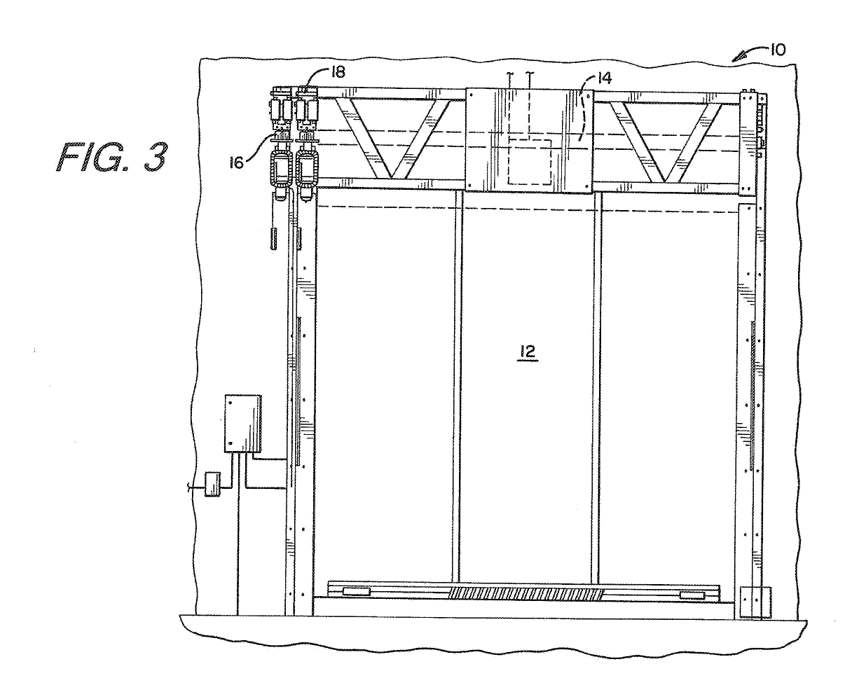

FIG. 1 shows an embodiment of an overhead door assembly as contemplated by the invention. As seen in FIG. 1, door assembly 10 includes a flexible roll-up door panel 12 which is wound and unwound to permit and prohibit access to an opening by rotating shaft 14. Shaft 14 is rotated by motors 16, 18. Though motors 16, 18 are shown as being on opposite sides of shaft 14 in FIG. 1, as shown in FIG. 3, it is contemplated by the invention that motors 16, 18 may be located on the same side as shaft 14. FIGS. 1 and 3 also each show the use of two motors, however it should be appreciated by those having ordinary skill in the art that any number of additional motors may be used with the system in order to add safety to the door assembly, better control larger door panels, or to allow for continued operation of the door if a motor or motors fail during the opening or closing cycle. Utilizing at least two motors has the advantage of allowing for smaller motors to be used to vertically move larger door panels, thereby reducing the size of the motor, any door header or other components housing the motor, and the cost and complexity of the motor used to rotate the shaft and to vertically move the door panel. Utilizing at least two motors may allow for overhead doors having very large door panels to be used to open and close larger openings. As is further explained herein, utilizing at least two motors alone, or in association with larger gears associated with the rotating shaft may also prevent the door panel from closing or collapsing should one motor fail, and may even allow for the door panel to be opened or closed by the other motor to facilitate repair of the door assembly while insuring a particular opening is opened or closed. Having at least two motors also allows for a fully functional and operational door panel without using torsion springs or counterweights.

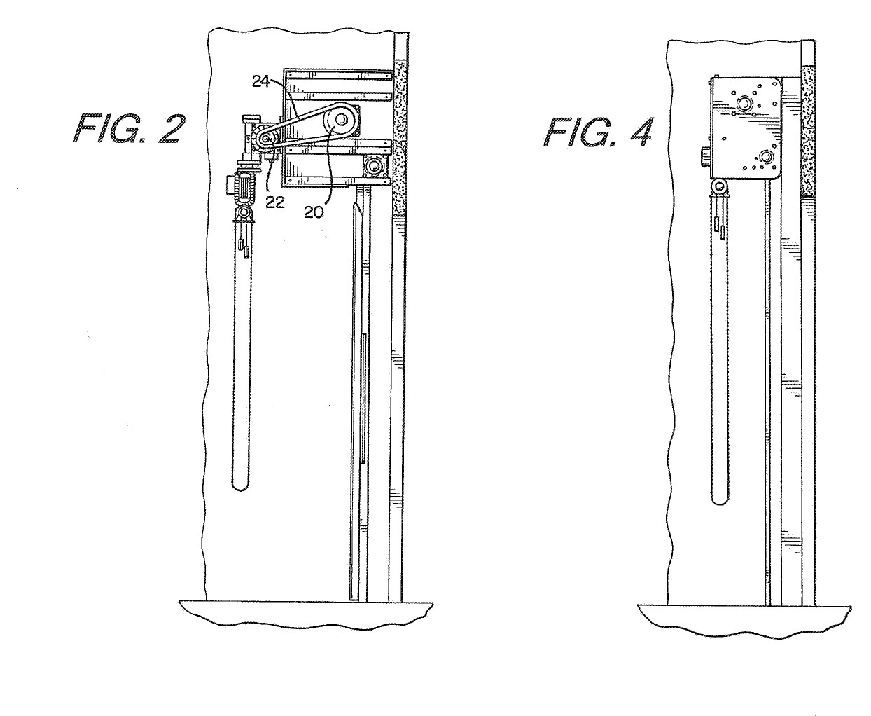

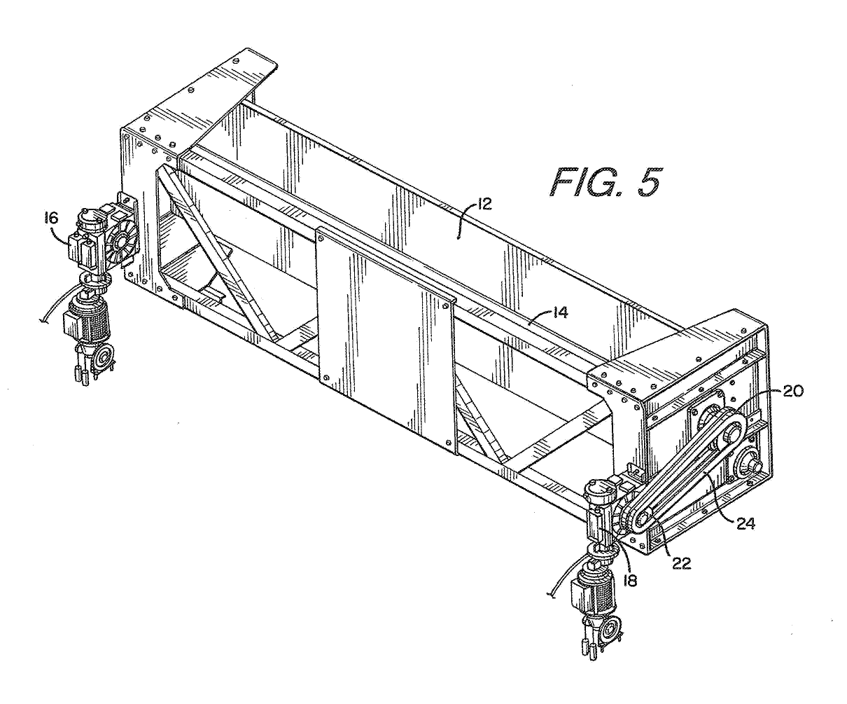

While motors 16, 18 may be connected to and rotate shaft 14 in the conventional manner known in the art—e.g. by attaching the motors directly to the shaft—as seen in FIGS. 1-5, in one embodiment, the shaft contains at least two gears on the shaft (shaft gears 20) which are operably engaged with a gear on each motor (motor gears 22). The shaft and motor gears may be directly engaged, i.e. a toothed motor gear engages a toothed shaft gear, or may be engaged using a flexible engagement member 24, like for example a chain or belt. Regardless of how the gears are engaged, it is contemplated by the invention that each motor gear engages only a single shaft gear and that each motor gear may have a substantially equal diameter. Each shaft gear likewise may have a substantially equal diameter.

While it is contemplated by the invention that any diameter ratio between the motor gears and the shaft gears may be used, in a preferred embodiment the shaft gears have a larger diameter than the motor gears. Utilizing larger diameter shaft gears will increase the ability of the motors and shaft to hold the door panel in a partially or fully opened position if the door panel becomes stopped and suspended for any reason, as the larger shaft gear may increase the torque required to rotate the shaft and vertically move the door panel. Using additional motors may likewise enhance this ability of the assembly to hold a partially opened door in a suspended position.

The ability to hold a suspended door panel and prevent it from collapsing may be further enhanced, if, for example, the shaft gears and motor gears are operably engaged utilizing a chain wound around both gears. Any chain that is used to engage a motor and shaft gear should be of sufficient size and strength to allow a single motor to hold a suspended door panel if the other motor fails or becomes disengaged from its shaft gear. That is, the combination of the motor, motor gear, chain, and shaft gear should be sufficiently strong enough to prevent a door panel from collapsing or closing if the door panel is stopped or prevented from moving because of the failure of the other motor or the other motor gear becoming disengaged from the other shaft gear. Increasing the size of the shaft gear only enhances the ability of the motor to hold the panel.

In order to insure that each motor, motor gear, and shaft gear combination is functioning properly, the door assembly may include one or more sensors. Each sensor may be used to measure or detect a motor or door parameter and be configured to prohibit the vertical movement of the door panel if a value or door element is not detected.

For example, the door assembly may include at least one sensor for detecting the operation of each motor used to raise and lower the door panel. If the at least one sensor detects that either motor fails, it may provide a control signal to a door controller to stop the door panel if it is moving, and prevent anyone from opening or closing the door panel using either of the motors. Sensors which may be used to detect the operation of each motor may detect the current or voltage drawn or provided to each motor to insure the motor is being provided and utilizing the ideal amount of current and/or voltage. Utilizing at least one current sensor may also allow for the stress on each motor to be monitored, by, for example, detecting the amount of current drawn by the motor to maintain rotation and vertically move the door panel. If any sensor coupled to a motor detects that a particular motor is not receiving voltage and/or current, or is drawing too much current to continue moving the door panel, the sensor may provide a signal to prohibit movement of the door panel by the motors.

Alternatively or in addition to any electrical sensors for each motor, the rate of rotation of each motor shaft may be measured by at least one sensor to insure the shaft is rotating. In addition to sensing rotation of each motor shaft to determine that each motor is working, sensors detecting the rate of rotation may also be used to insure that the motors are substantially synchronized and rotating the shaft at substantially the same rate to insure that the door panel is opened and closed in a substantially uniform manner. Sensors which may be used to detect the rate of rotation of each motor include but are not limited to sensors detecting the rate of rotation of the motor shaft, sensors counting the revolutions of a gear or any flexible engagement members by mechanically or optically tracking a particular point on the gear or member, sensors optically or mechanically counting the rate of revolution of the shaft or drum proximate each motor, or optically or mechanically sensing the amount of door panel wound or unwound from the shaft. As with any electrical sensors, if any sensors used to detect the rate of rotation of the motor determine that the motors are not substantially synchronized and are not rotating the shaft at substantially the same rate, the sensor may provide a control signal to prohibit the vertical movement of the door panel by the motors.

In addition to, or in the alternative of any of the aforementioned sensors, at least one sensor may be used to measure the torque of each motor. As with each of the aforementioned sensors, if the value of the torque measured at each motor is outside an acceptable range, the at least one sensor may provide a control signal to prohibit the vertical movement of the door panel by the motors.

The door assembly may also include at least one sensor to insure that each motor gear is operably engaged with a shaft gear, particularly when a flexible member is used to engage the motor gears and shaft gears. Sensors which may be used to detect engagement of each gear include but are not limited to, proximity sensors, contact or mechanical sensors, or optical sensors. Once again, the door assembly may be configured so that the at least one sensor provides a control signal to prevent vertical movement of the door panel by the motors if any motor gear becomes disengaged from its respective shaft gear.

If vertical movement of the door panel by the motors is prohibited for any reason, it is contemplated by the invention that at least one manual means of vertically moving the door panel may be provided. The manual means for moving the door panel may include, for example, a belt, chain, or rope connected to at least one of a motor, motor gear, shaft gear, or shaft which can be pulled by an individual to rotate the shaft in the proper direction to wind or unwind the door panel. In order to insure proper winding and unwinding of the door panel, it is contemplated by the invention that one manual means of rotating the gears and/or shaft may be attached to each motor or proximate each end of the shaft. Rotating each manual means at a substantially similar rate will insure that the door panel opens and closes in a substantially uniform manner.

The above-described embodiments of the present invention are intended to be examples only. Alterations, modifications and variations may be effected to the particular embodiments by those of skill in the art without departing from the scope of the invention, which is defined by the claims appended hereto.

What is claimed is:

1. An overhead roll-up door assembly for a vertically moving door to permit and prohibit access to an opening, the door assembly comprising:
a flexible door panel;
a shaft capable of rotating to vertically move the flexible door panel; and,
at least two motors configured to rotate the shaft.

2. The overhead roll-up door assembly of claim 1 wherein
the shaft includes at least two shaft gears having a substantially identical diameter;
each of the motors including a motor gear coupled to a motor shaft, the motor gears having a substantially identical diameter less than the substantially identical diameter of the shaft gears;
wherein each motor gear is operably engaged with one shaft gear by at least one of a chain or a belt.

3. The overhead roll-up door assembly of claim 2 wherein each gear shaft is located proximate an end of the shaft.

4. The overhead roll-up door assembly of claim 2 further comprising at least one sensor for detecting the operable engagement between at least two shaft gears and the at least two motor gears.

5. The overhead roll-up door assembly of claim 4 wherein the at least one sensor is a proximity sensor.

6. The overhead roll-up door assembly of claim 4 wherein the at least one sensor is a contact sensor.

7. The overhead roll-up door assembly of claim 4 wherein the at least one sensor is an optical sensor.

8. The overhead roll-up door assembly of claim 4 wherein vertical movement of the door panel is prohibited if either motor gear becomes disengaged from its respective shaft gear.

9. The overhead roll-up door assembly of claim 1 wherein the at least two motors are configured to rotate the shaft at substantially the same rate.

10. The overhead roll-up door assembly of claim 9 further comprising at least one sensor for detecting rate of rotation of each motor.

11. The overhead roll-up door assembly of claim 10 wherein the at least one sensor detects the rate of rotation of each motor shaft.

12. The overhead roll-up door assembly of claim 11 wherein the at least one sensor determines the rate of rotation by tracking a marking on the member operably engaging each motor gear to its respective shaft gear.

13. The overhead roll-up door assembly of claim 11 wherein the at least one sensor determines the rate of rotation by monitoring the amount of door panel wound or unwound from the shaft.

14. The overhead roll-up door assembly of claim 10 wherein vertical movement of the door panel is prohibited if the rates of rotation of the at least two motors are not substantially identical.

15. The overhead roll-up door assembly of claim 1 further comprising at least one sensor for detecting the current drawn by the at least two motors.

16. The overhead roll-up door assembly of claim 1 further comprising at least one sensor for detecting a torque required by each motor to vertically move the door panel.

17. The overhead roll-up door assembly of claim 16 wherein vertical movement of the door panel is prohibited if the torque required by either motor exceeds a set threshold.

18. The overhead roll-up door assembly of claim 1 further comprising at least one manual means for operating the motor and rotating the shaft.

19. The overhead roll-up door of claim 18 wherein the means for operating the motor and rotating the shaft is an emergency pull chain attached to at least one motor.

20. The overhead roll-up door of claim 19 wherein one emergency pull chain is attached to each motor.
